(19) United States
(12) Patent Application Publication
(10) Pub. No.: US 2023/0077124 A1
(43) Pub. Date: Mar. 9, 2023

(54) Duty Cycle Protocol for Driving a Matrix of LEDs

(71) Applicant: Methode Electronics Malta Ltd., Birkirkara (MT)

(72) Inventors: Ashraf M. Edwila, Canton, MI (US); Tim Green, Holly, MI (US)

(21) Appl. No.: 17/897,381

(22) Filed: Aug. 29, 2022

(30) Foreign Application Priority Data
Sep. 3, 2021 (DE) 102021122916.2

(51) Int. Cl. H05B 47/155

(52) U.S. Cl. CPC H05B 47/155

(57) ABSTRACT

A method for driving LEDs involves arranging the LEDs in a matrix. The LEDs are designed as RGB LEDs and are driven by means of a duty cycle control protocol.

### RELATED APPLICATION DATA

This application claims priority benefit to German patent application serial no. DE 10 2021 122 916.2, filed Sep. 3, 2021, the disclosure of which is incorporated by reference herein.

### DESCRIPTION

The disclosure refers to a method for driving LEDs that are arranged in a matrix. The LEDs are designed as RGB LEDs and are driven by means of a duty cycle control protocol.

### BACKGROUND ART

In previous LED applications multiple integrated circuits (ICs) are used. An electronic circuit is formed on a small piece of semiconducting material, which performs the same function as a larger circuit made from discrete components.

Each IC is capable of driving up to 24 individual LEDs.

Further applications known in the art use at least two drivers to control a matrix of LEDs.

LEDs are commonly used in a plurality of appliances from the automotive industry to basic practical appliances.

### OBJECTIVE OF THE INVENTION

It is one objective of the invention to optimize the overall circuit of a LED system and to extend the capability of a LED driver.

It is another objective of the invention to increase the efficiency of the LEDs as such.

Both the cost effectiveness and the power requirement of the LED system should also be improved.

Furthermore, the manageability of the LED system should be set to a higher level.

### Solution

The objectives are achieved by a method for driving LEDs. The LEDs are arranged in a matrix.

The LEDs are designed as RGB LEDs.

Also, the LEDs are driven by means of a duty cycle control protocol.

### LED (Light Emitting Diode)

The light emitting diode is referred to in the following as LED. The LED represents a semiconductor light source, which emits light when a current flows through the semiconductor.

Electrons in the semiconductor recombine with electron holes releasing energy in the form of photons.

The colour of the LED light corresponds to the energy of the photons.

In other words, the colour of the light of the LED is determined by the energy required by the electrons to cross a band gap of the semiconductor.

By way of example, white light is obtained when multiple semiconductors or a layer of light emitting phosphor on the semiconductor device is used.

Modern LEDs are available across the visible, ultraviolet and/or infrared wave length achieving a high light output.

LEDs generating a high output of white light are available for in-house and/or outdoor lighting.

Modern LEDs are used in diverse applications such as aviation lighting, fairy lights and/or automatic headlamps.

Modern LEDs are also used for advertising purposes and/or for general lighting.

LEDs may be deployed in traffic lights or in camera flashes. It goes without saying that LEDs can also be used in a variety of further applications.

### Duty Cycle Control Protocol of the LED

A duty cycle or a power cycle of the LED represents the fraction of a period in which the LED is active. The period being the time it takes for a signal of the LED to complete an on-and-off-cycle.

Example: The “on time” for a 60 percent duty cycle could be a fraction of a second and/or a fraction of a day and/or even a fraction of a week. Obviously, the fraction depends on a length of the period (second, hour, day, week).

Thus, the duty cycle of the LED can be used to describe the percent time of an active signal in the LED.

The control protocol refers to a communication standard. It enables (i.e.) the application programs and/or the computing devices to exchange messages over the control protocol of the LED.

### RGB Led

The term RGB LED stands for a combination of three LEDs in just one package.

The RGB LED is a light combined of one red LED and one green LED and one blue LED.

By using a set of RGB LEDs one can generate light of almost any colour.

Using the RGB LEDs, an individual red light or an individual green light or an individual blue light can be created.

When the intensity of each LED (red, green, blue) is configured, almost any other colour can be generated as well.

Example: When a purely blue light colour is required the blue LED is chosen at its highest intensity. In addition, the green LED and the red LED however are added in their lowest intensity.

To produce a white colour all three RGB LED have to be set at approximately equal intensity.

In other words, to create other colours than red or blue or green, the available RGB LEDs (red, green, blue) are combined using the respective colours (red, green, blue) in different intensities.

It goes without saying that the intensity of each RGB LED can be adjusted by using a so called Pulse Width Modulation (PWM) signal. PWM describes a type of digital signal. PWM is used in a variety of applications including sophisticated control circuitry. PWM signals are commonly used to control dimming of RGB LEDs.

With the RGB LEDs being very close to each other the human eye sees the result of the combination of the RGB LEDs rather than the individual RGB LEDs (red, green, blue) as such.

### Fluid Animation

The term fluid animation refers to computer graphic techniques for generating realistic animation of fluids.

The realistic animation of the fluid may refer to water and/or smoke.

Typically, fluid animations focus on emulating the qualitative visual behaviour of the fluid.

Less emphasis is placed on rigorously correct physical results. The fluid animation can be performed with different levels of complexity.

The levels of complexity may range from high quality animation for films and/or movies or visual effects to simple and fast animations for real time animations such as computer games.

It goes without saying that the fluid animation can also be used for computational fluid dynamics. Here, the fluid animation is used primarily for visual effects.

Computational fluid dynamics can be used for scientific purposes to improve the study of the fluid as such.

### EMBODIMENTS OF THE INVENTION

According to an embodiment of the invention the LEDs are arranged in a matrix to give an effect of a fluid animation.

According to another embodiment of the invention the matrix of LEDs comprises at least two LEDs.

A further embodiment of the invention reveals that the LEDs are arranged as a strip of at least two LEDs.

In another embodiment of the invention LEDs are driven by means of a programmable IC. The LEDs may also be driven by means of multiple ICs.

According to another embodiment of the invention, a driver of the LEDs is controlled by means of a microcontroller.

### Advantages of the Invention

According to the invention, a matrix of at least two individual RGB LEDs can be used.

Thus, the number of RGB LEDs can be increased to a matrix comprising 64 RGB LEDs.

At least one programmable IC is sufficient to control and/or to manipulate the RGB LEDs.

Also, a microcontroller can be applied to control a driver of the RGB LEDs.

The matrix of RGB LEDs provides an effect of a fluid animation. When the duty cycle control protocol is used to control the RGB LEDs, the previous benefits of the LED system are maintained.

The duty cycle control protocol individually manages and/or controls at least two RGB LEDs.

Also, a transceiver can be used to communicate with a master module.

### DRAWINGS

The invention is described in more detail with the help of a schematic circuit diagram, wherein:

FIG. 1 shows a schematic diagram of a circuit of eight LEDs,

FIG. 2 shows a schematic diagram of a circuit of three LEDs and

FIG. 3 shows a schematic diagram, comprising two or more packages of LEDs.

### DETAILED DESCRIPTION

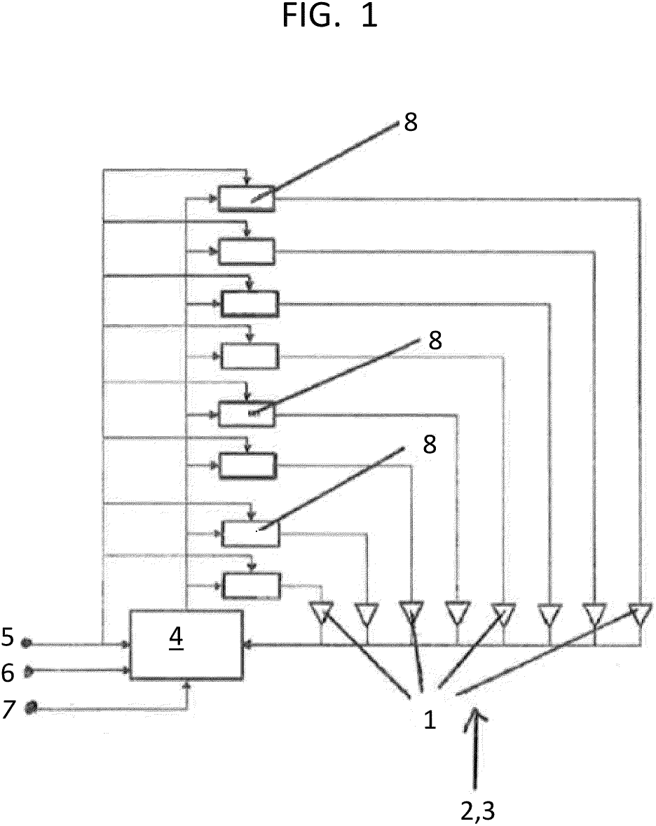

In FIG. 1 the LEDs 1 are shown in a matrix 2 of eight LEDs 1.

The LEDs 1 are arranged parallel 3 to each other.

A controller 4 communicates with a battery 5. The controller 4 is grounded at the reference digit 6.

A local interconnector network (LIN) is shown with reference numeral 7.

Each LED 1 is connected to a so-called MOSFET switch 8, respectively. The MOSFET switch 8 is a metal-oxide-semiconductor field-effect transistor. It goes without saying that other switches can also be used.

Each MOSFET switch 8 draws electrical energy from the battery 5.

In addition, each MOSFET switch 8 is connected to the controller 4.

In the FIG. 1 the local interconnection network (LIN) 7 is connected to the controller 4.

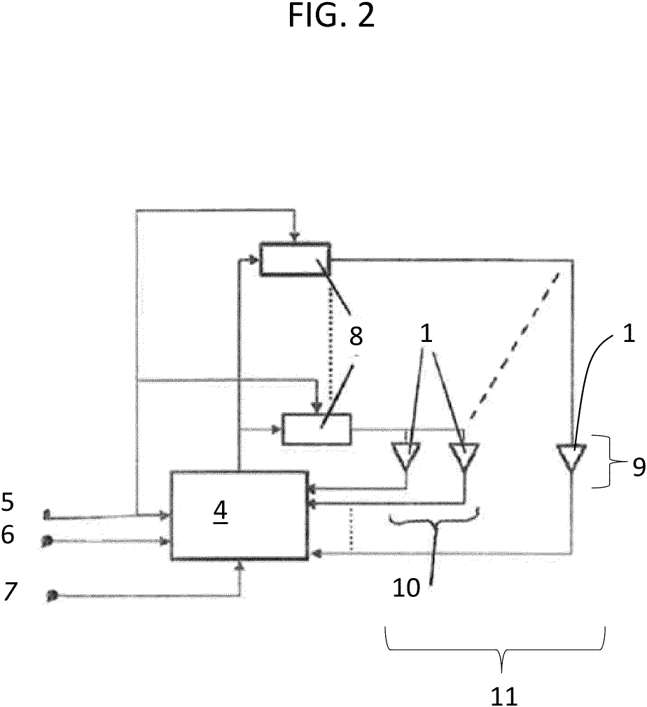

In FIG. 2 three LEDs 1 are arranged serially 11 in a package of two sets 9, 10 of LEDs 1. Set 9 includes one LED 1, while set 10 shows two LEDs 1.

The FIG. 2 shows that the controller 4 communicates with a battery 5. Also, the controller 4 is grounded at the reference digit 6.

A local interconnector network (LIN) is shown with reference numeral 7.

In the FIG. 2 the LEDs 1 are connected to the MOSFET switches 8. However, in the LED set 9 (comprising one single LED 1) the single LED 1 is connected to the MOSFET switch 8 individually.

In the LED set 10 (comprising one pair of two LEDs 1) the two LEDs 1 are connected to one MOSFET switch 8 as a pair.

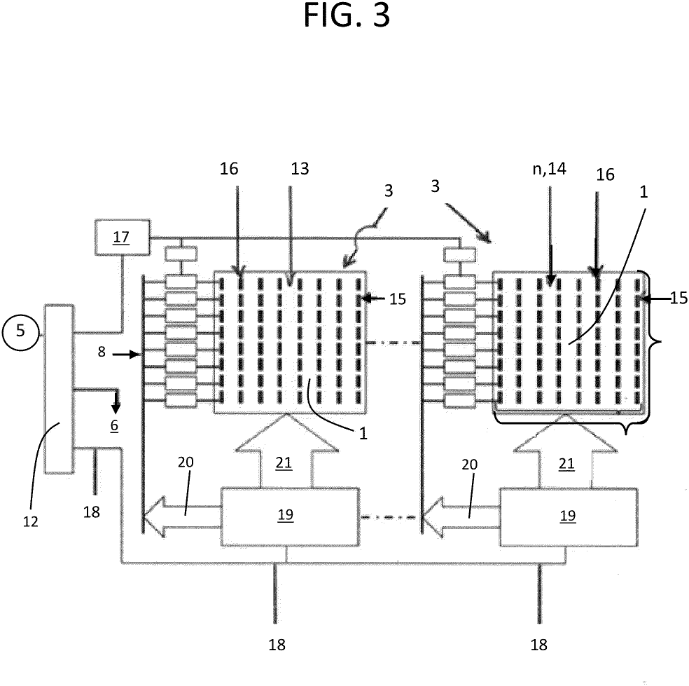

FIG. 3 shows a diagram, wherein a number of two to n packages 13, 14 of LEDs 1 are arranged in parallel 3.

By way of example, FIG. 3 shows two packages 13, 14, with each package 13, 14 comprising individual LEDs 1, respectively.

By way of example the package 13, 14 may comprise a number of 192 LEDs 1. It goes without saying that there may also be another number of LEDs 1 arranged per package 13, 14.

In the example of FIG. 3 the packages 13 and 14 of LEDs 1 are arranged in parallel 3. Each package 13, 14 comprises eight vertical columns 16 of eight LEDs 1, respectively.

Each package 13, 14 of LEDs 1 comprises eight horizontal rows 15 of eight LEDs 1, each.

A multi-purpose connector 12 supplies electrical energy from the battery 5 to MOSFET switches 8.

The MOSFET switches 8 draw electrical energy from the battery 5, wherein a so-called buck regulator 17 is arranged between the MOSFET switches 8 and the multi-purpose connector 12.

Preferably, the buck regulator 17 is a DC (direct current) to DC power converter. The buck regulator 17 steps down a voltage value from its input (supply) to its output (load). The buck regulator 17 serves both the package 13 of the LEDs 1 and the package 14 of the LEDs 1.

In the FIG. 3 the package 14 is also referred to as package n. Thus, between the package 13 and the package 14 (package n) any number of additional packages 13, 14, ... n can be implemented.

The multi-purpose connector 12 is grounded at the reference digit 6.

In the FIG. 3 a controller interconnector network (LIN) 18 connects the multi-purpose connector 12 to two microcontroller 19, with one microcontroller 19 being arranged per package 13, 14, ... n of the LEDs 1.

Each microcontroller 19 is connected via a general purpose input output (GPIO) 20 to the MOFETS 8 of the package 13, 14 to which the respective microcontroller 19 is assigned by links 21.

In the example of FIG. 3 a number of lines 21 link the microcontroller 19 to the respective package 13, 14, ..., n of the LEDs 1.

### List of References

1 LED

2 Matrix

3 Parallel

4 Controller

5 Battery

6 Ground

7 LIN

8 MOSFET

9 Set of LED

10 Set of LED

11 Serially

12 Multi-purpose connector

13 Package of LEDs

14 Package of LEDs

15 Row of LEDs

16 Column of LEDs

17 Buck regulator

18 LIN

19 Microcontroller

20 General purpose input/ output

21 Links

What is claimed is:

1. A method for driving LEDs comprising:
arranging the LEDs are in a matrix, wherein the LEDs comprising RGB LEDs; and
driving the LEDs with a duty cycle control protocol.

2. A method for driving LEDs according to claim 1 wherein the step of arranging the LEDs in the matrix comprises arranging the LEDS in the matrix to give an effect of a fluid animation.

3. A method for driving LEDs according to claim 1 wherein the step of arranging the LEDs in the matrix comprises providing at least two LEDs in the matrix of LEDs.

4. A method for driving LEDs according to claim 1 wherein the step of arranging the LEDs in the matrix comprises arranging the LEDs at least as a single strip of at least two LEDs.

5. A method for driving LEDs according to claim 1 wherein the step of driving the LEDs with the duty cycle protocol comprises driving the LEDS with a programmable IC.

6. A method for driving LEDs according to claim 1 wherein the step of driving the LEDs with the duty cycle protocol comprises driving the LEDS with multiple ICs.

7. A method for driving LEDs according to claim 1 wherein the step of driving the LEDs with the duty cycle protocol comprises driving the LEDS with a microcontroller.
